(19) United States
(12) Patent Application Publication
(10) Pub. No.: US 2024/0055643 A1
(43) Pub. Date: Feb. 15, 2024

(54) NEGATIVE ELECTROLYTE MANAGEMENT SYSTEM

(71) Applicant: ESS TECH, INC., Wilsonville, OR (US)

(72) Inventors: Sean Kissick, Portland, OR (US); Timothy J. McDonald, Portland, OR (US); Yang Song, West Linn, OR (US)

(21) Appl. No.: 18/358,877

(22) Filed: Jul. 25, 2023

Related U.S. Application Data
(60) Provisional application No. 63/370,854, filed on Aug. 9, 2022.

(51) Int. Cl. H01M 8/18; H01M 8/04276; H01M 8/0438; H01M 8/04746; F17C 5/06

(52) U.S. Cl. CPC H01M 8/188; H01M 8/04276; H01M 8/04425; H01M 8/04776; F17C 5/06; F17C 2201/018; F17C 2205/0134; F17C 2223/031; F17C 2225/033; F17C 2205/0332; F17C 2250/043; F17C 2221/012; F17C 2250/0647; F17C 2250/03

(57) ABSTRACT

Systems and methods are provided for managing health of electrolytes of redox flow battery system. Components of the system may include a redox rebalancing cells and a gas storage system. The redox rebalancing cell may be operated by plating iron on a plating electrode, treating a negative electrolyte of the redox flow battery system with the plated iron and returning the negative electrolyte to an electrolyte tank. The gas storage system may include a set of expandable gas storage tanks coupled to at least one electrolyte storage tank and an electrolyte rebalancing system of the redox flow battery system.

### CROSS REFERENCE TO RELATED APPLICATIONS

The present application claims priority to U.S. Provisional Application No. 63/370,854 entitled “NEGATIVE ELECTROLYTE MANAGEMENT SYSTEM” filed Aug. 9, 2022. The entire contents of the above identified application is hereby incorporated by reference for all purposes.

### FIELD

The present description relates generally to systems and methods for rebalancing electrolytes during operation of a redox flow battery system.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

H⁺+e↔½H₂(proton reduction) (1)

Fe⁰+2H⁺↔Fe²⁺+H₂(iron corrosion) (2)

2Fe³⁺+Fe⁰↔+3Fe²⁺(iron plating oxidation) (3)

As most side reactions occur at the plating electrode, IFB cycling capabilities may be limited by available iron plating on the plating electrode. In addition to reducing an amount of plated Fe⁰, a presence of Fe³⁺ in a negative electrolyte may result in unwanted precipitation of iron hydroxides due to a higher pH of the negative electrolyte. Aside from diminishing a capacity of the redox flow battery, iron hydroxide precipitates may be undesirable due to their ability to clog fluid passages of the redox flow battery and coat a non-conductive layer on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe³⁺) from equation (3) by ion crossover via equation (4):

Fe³⁺+½H₂→Fe²⁺+H⁺(electrolyte rebalancing) (4)

In some examples, to achieve relatively high rebalancing performance with relatively low amounts of H₂ gas, a rebalancing reactor wherein equation (4) occurs may be included in the redox flow battery system. The rebalancing reactor may include a stack of electrode assemblies, each electrode assembly including positive and negative electrodes in face-sharing contact with one another such that the positive and negative electrodes may be continuously electrically conductive (e.g., at surfaces of the positive and negative electrodes in face-sharing contact).

In some examples, the electrolyte rebalancing of equation (4) may be realized via a fuel cell setup, where the H₂ gas and the electrolyte may react at catalyst surfaces driven by direct current applied to positive and negative electrodes of the rebalancing cell. In other examples, a trickle bed or jelly roll reactor setup may similarly include catalyst surfaces whereon the H₂ gas and the electrolyte may react.

The H₂ gas may be evolved from side reactions described by equations (1) and (2) as above and collected from electrolyte storage tanks to be stored in an expandable gas storage tank fluidly coupled to the electrolyte storage tanks and to the rebalancing reactors. A pressure of gas inside the expandable gas storage tank may be monitored to determine if gas is to be released to mitigate over pressure events or if gas is to be stored for subsequent delivery to the rebalancing reactors. However, it may be difficult to determine a volume of gas available in the expandable tank due to minimal changes in tank pressure that may be difficult to measure at the expandable gas storage tank as it increases in volume.

In one example, the above issues may be addressed by a gas storage system including a first tank fluidly coupled to a second tank. The first tank may be a smaller auxiliary tank and the second tank may be a larger main tank. A weight may be unevenly distributed across the main tank. A change in pressure in the weighted main tank may be readily detected and provide a linear signal at a pressure transducer which may be readily interpreted by a controller. Further the first auxiliary tank may provide a buffer, allowing time for the gas storage system to be decoupled from the rebalancing reactor if the main tank is determined to be empty.

Additionally, rebalancing reactions using H₂ gas according to electrolyte rebalancing equation (4) may demand a catalyst for the rebalancing equation to proceed at an appreciable rate. The catalyst may contribute to an initial high cost of the rebalancing reactor and may demand further maintenance and system down-time for cleaning and regeneration due to catalyst fouling during the course of regular operation.

In one example the issues describe above may be at least partially addressed by a redox rebalancing cell based on equation (3) above using Fe⁰ as a reducing agent for reducing Fe³⁺ to Fe²⁺. A redox rebalancing cell operating based on equation (3) may decrease a concentration of Fe³⁺ in the negative electrolyte without using an expensive catalyst. Lack of an expensive catalyst may reduce a start-up cost of the redox rebalancing cell. Further, the redox rebalancing cell may demand less maintenance due to the lack of catalyst to clean and recover. The Fe⁰ may be sacrificially generated from Fe²⁺ present in the positive electrolyte. In an alternate embodiment, Fe⁰ may be provided by the negative plating electrode. Fe⁰ provided by the plating electrode may help to remediate uneven plating of Fe⁰ at the negative endplate electrode.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including an electrolyte management system and a hydrogen storage tank.

FIG. 2 shows a first example of a redox rebalancing cell coupled to a negative electrolyte of the redox flow battery.

FIGS. 3A-3B show stages of operating a redox rebalancing cell according to a second example of a redox rebalancing cell coupled to negative electrolyte of the redox flow battery.

FIGS. 4A-4C shows of filling an example of a hydrogen gas storage system.

FIG. 5 shows a plot of gas volume as function of gas pressure stored in the hydrogen gas storage system of FIGS. 4A-4C.

FIG. 6 shows an example of a method for operating a redox rebalancing cell.

FIG. 7 shows an example of a method for operating a gas storage system.

### DETAILED DESCRIPTION

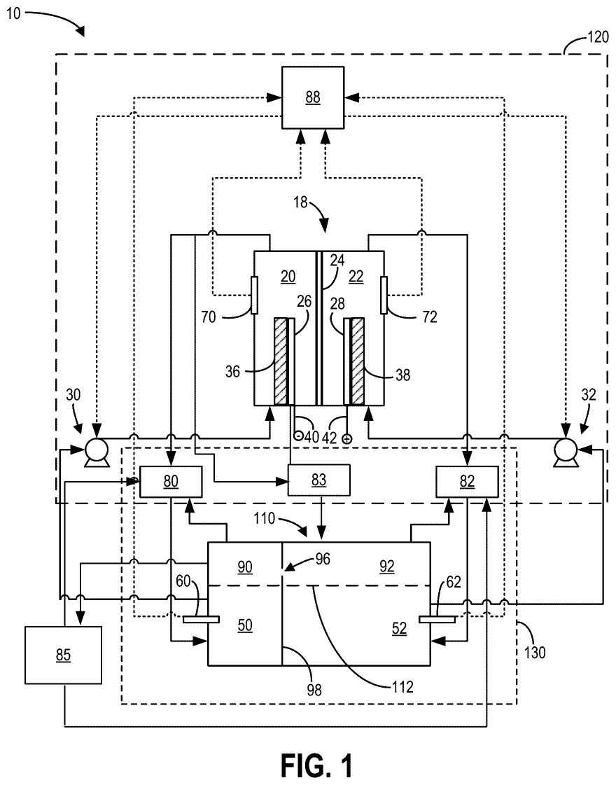

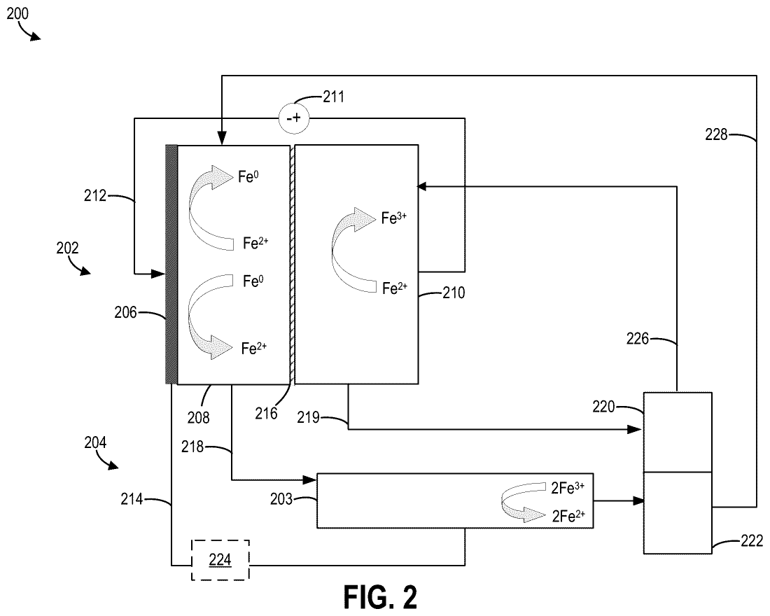

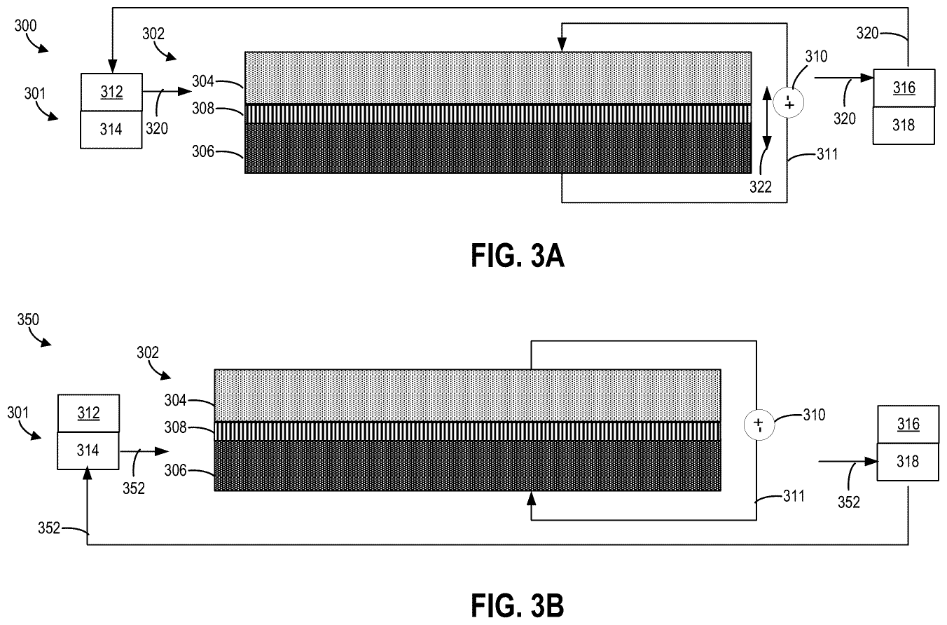

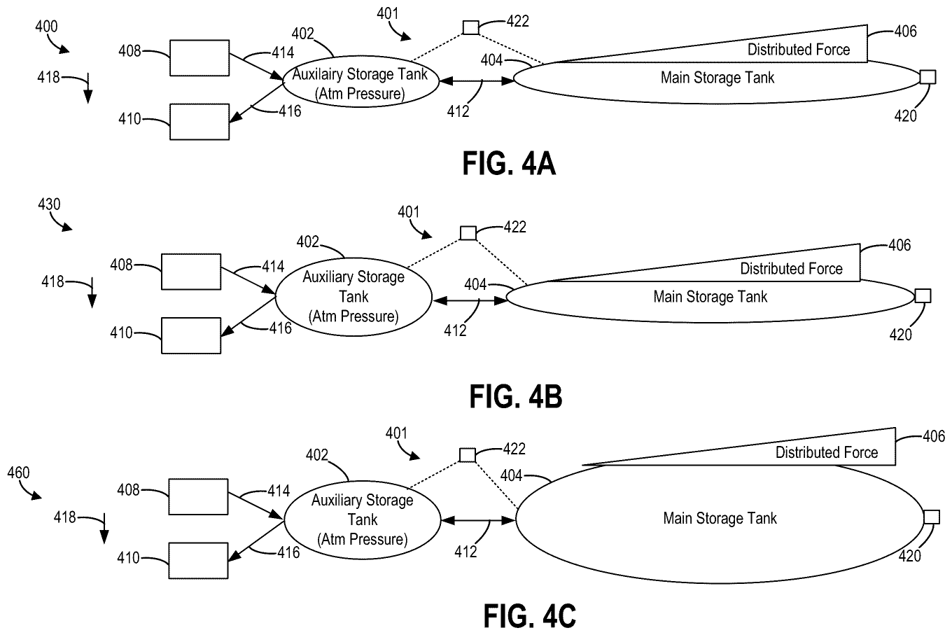

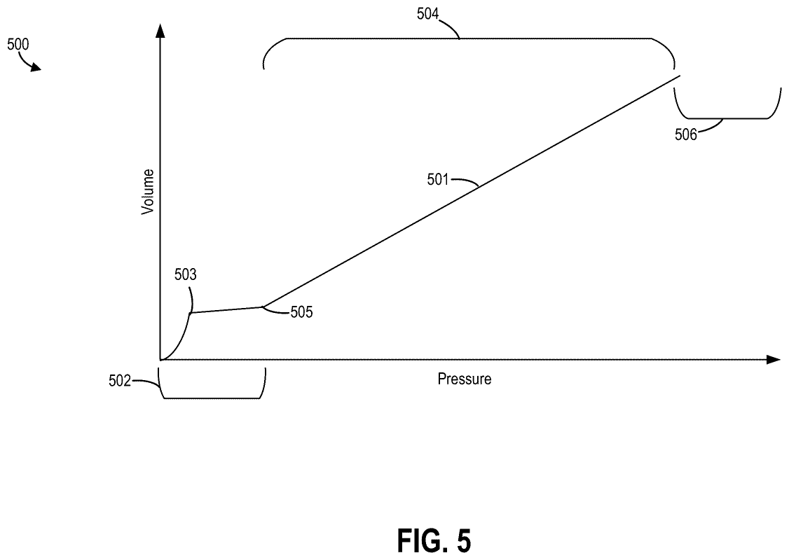

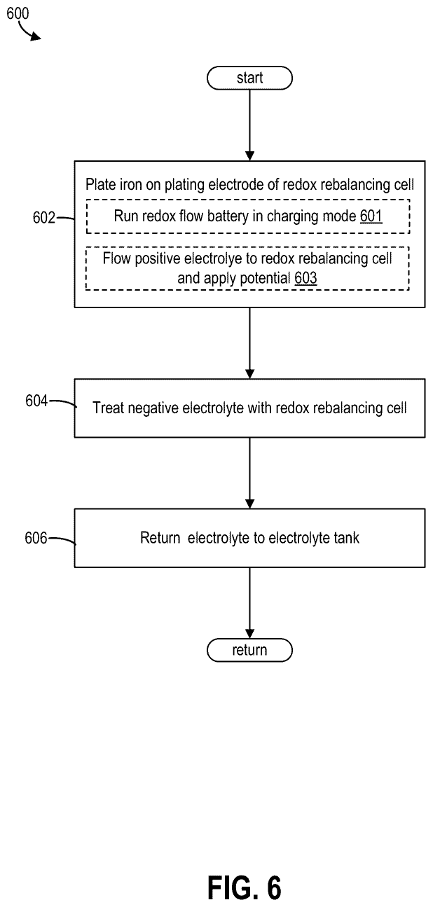

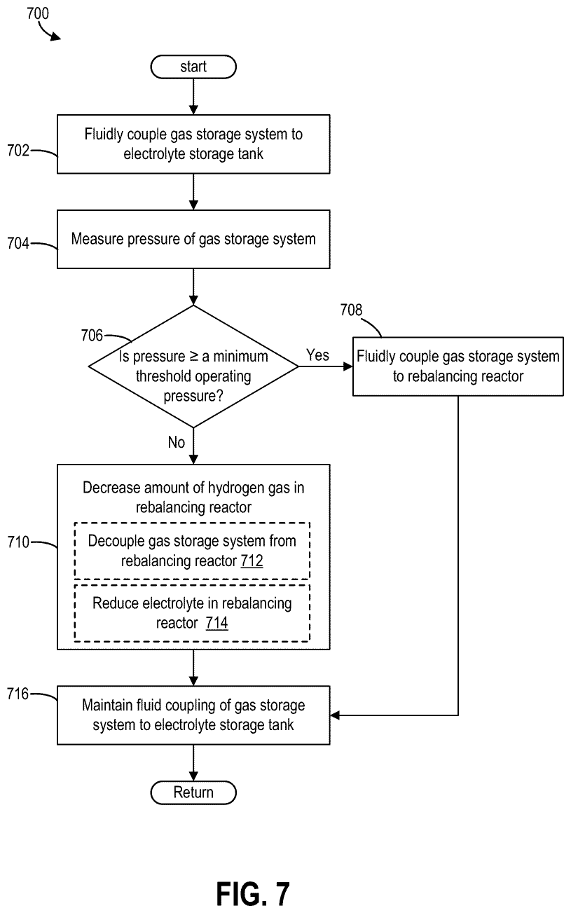

The following description relates to systems and methods for rebalancing electrolytes of a redox flow battery. In an exemplary embodiment, rebalancing cells may be fluidly coupled to an electrolyte subsystem, each included in an electrolyte management system of the redox flow battery system. The redox flow battery system is depicted schematically in FIG. 1 with an integrated multi-chamber tank having separate positive and negative electrolyte chambers (e.g., for respectively storing positive and negative electrolytes) and respective gas head spaces. In one embodiment, negative electrolyte may be maintained (e.g., Fe³⁺ reduced) by a redox rebalancing cell fluidly coupled to a negative electrolyte chamber, capable of reducing undesirable Fe³⁺ to Fe²⁺ using plated Fe⁰ as the reducing agent. Herein, a redox rebalancing cell may be configured to use Fe⁰ to reduce Fe³⁺ to Fe²⁺. In one example, the Fe⁰ may be the Fe⁰ plated on a plating electrode of redox flow battery system. The negative plating electrode electrically shorted to an electrode of the redox rebalancing cell is shown in FIG. 2. In an alternate embodiment, the Fe⁰ may be formed on a plating electrode of the redox rebalancing cell by reducing excess Fe²⁺ of the positive electrolyte as shown in FIGS. 3A-3B. The redox rebalancing cell may be used in addition to a catalyst-based rebalancing cell that uses H₂ gas to reduce Fe³⁺ in the presence of a catalyst. Herein, such a rebalancing cell may be referred to as a hydrogen catalytic rebalancing cell. In some examples, a positive electrolyte may be maintained by passing the positive electrolyte through the hydrogen catalytic rebalancing cell and/or the redox rebalancing cell. Hydrogen gas may be generated by side reactions as described above with respect to equations (1) and (2) and stored as shown in FIGS. 4A-4C for use as a reactant in the catalytic rebalancing cell. An effect of gas pressure on gas volume in the gas storage system of FIGS. 4A-4C is plotted in a graph in FIG. 5. A method for rebalancing the negative electrolyte using the redox rebalancing cell, as shown in FIGS. 2-3B, is shown in FIG. 6. A method for operating a gas storage system of FIGS. 4A-4C, is shown in FIG. 7.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (5) and (6), wherein the forward reactions (left to right) indicate electrochemical reactions during battery charge, while the reverse reactions (right to left) indicate electrochemical reactions during battery discharge:

Fe²⁺+2e⁻↔Fe⁰−0.44 V (negative electrode) (5)

2Fe²⁺↔2Fe³⁺+2e⁻+0.77 V (positive electrode) (6)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, where the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

In some examples, Fe(OH)₃ precipitation may also be addressed by incorporating a redox rebalancing cell that is fluidly coupled to the negative electrode compartment 20. The redox rebalancing cell may reduce the Fe³⁺ back to Fe²⁺ before Fe(OH)₃ forms. The redox rebalancing cell may maintain an all iron chemistry, using Fe⁰ as the reducing agent.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

The redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. Further, a gas head space 90 may be located above the fill height 112 of the negative electrolyte chamber 50, and a gas head space 92 may be located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

Gas head spaces 90 and 92 may also be fluidly coupled to a gas storage system 85. Gas storage system 85 may include an auxiliary tank and a main tank. Gas storage system 85 may be configured to store additional hydrogen gas, past the capacity of gas head spaces 90 and 92 and provide the additional hydrogen gas to rebalancing reactors 80 and 82. Gas storage system 85 may be described in further detail below with respect to FIG. 4A-4C.

The redox flow battery system 10 may further comprise a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 is placed in a return flow path from the negative and positive electrode compartments 20 and 22 to the negative and positive electrolyte chambers 50 and 52, respectively. In particular, by directing negative electrolyte through the electrolyte rebalancing reactors, short residence times are maintained for ferric iron in the negative electrolyte.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be reacted at catalyst surfaces in a packed bed with surfaces for carrying out the electrolyte rebalancing reaction. In this way, contact area between the three phases (e.g., H₂ gas, liquid electrolyte, and solid catalyst) may be increased. In other examples, the rebalancing reactors 80 and 82 may include flow-through type reactors that are also capable of reacting the H₂ gas and the electrolyte liquid and carrying out the electrolyte rebalancing reaction. Flow-through type reactors may include a lowered three phase contact area compared to trickle bed reactors, but may be simpler in design and therefore easier to operate.

In a further example, redox flow battery system 10 may include redox rebalancing cells 83. Redox rebalancing cells 83 may be included instead of or in addition to rebalancing reactors 80 and 82. The redox rebalancing cell 83 may be a shorted redox rebalancing cell, electrically coupled to negative electrode 26. The shorted redox rebalancing cell may be described further below with respect to FIG. 2. Alternatively, redox rebalancing cell 83 may be a sacrificial redox rebalancing cell, configured to plate sacrificial Fe⁰ (e.g., Fe⁰ that is sacrificed for use as a rebalancing agent and is not used for energy storage) that may be further used to reduce Fe³⁺ to Fe²⁺. The sacrificial redox rebalancing cell may be described further below with respect to FIGS. 3A-3B.

During operation of the redox flow battery system 10, sensors and probes may monitor and control chemical properties of the electrolyte such as electrolyte pH, concentration, SOC, and the like. For example, as illustrated in FIG. 1, sensors 62 and 60 may be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system, among others, may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. The separate dedicated hydrogen gas storage tank may be a gas storage system including an auxiliary tank and a main tank. The gas storage system may allow gas to be stored at lower pressures while still accurately determining a volume of gas available. In another example, as shown in FIG. 1, H₂ gas may be stored in and supplied from the integrated multi-chambered electrolyte storage tank 110. A headspace of the integrated multi-chambered electrolyte storage tank 110 may be filled with H₂ gas from side reactions (such as those shown in equations 1 and 2) occurring in the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a pump or other flow promoting device (which may be controlled by the controller 88) may direct flow of the H₂ gas from the integrated multi-chambered electrolyte storage tank 110. Rate of gas flow from the integrated multi-chambered electrolyte storage tank 110 may be controlled by a mass flow controller or other flow controlling device (which may be controlled by controller 88). The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 (e.g., from the headspace) in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIG. 7, the controller 88 may further direct gas to rebalancing reactors 80 and 82 from either a gas storage system, such as the gas storage system of FIGS. 4A-4C, or the headspace of the multi-chambered electrolyte storage tank 110. By referring to a calibration curve of the gas storage system, the controller 88 may determine if gas is to be obtained from the gas storage system or from the multi-chambered electrolyte storage tank 110, depending on an amount of gas available in the gas storage system. In another example, the controller 88 may direct a flow of either negative or positive electrolyte through the redox rebalancing cell according to a configuration of the redox balancing cell and an operating condition of the redox flow battery system, as described below with respect to FIG. 6. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 in excess, creating an imbalance between positive and negative energy levels. In this way a battery charge capacity during subsequent battery cycling (thus, the iron metal may be preformed for battery cycling) may be increased. The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase a usable SOC range during normal battery cycling. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

A conventional electrolyte management system may rely solely on catalytic hydrogen reduction (e.g., rebalancing reactors 80 and 82) to remediate Fe³⁺ in a negative electrolyte to Fe²⁺ using hydrogen supplied from a single flexible storage tank. A pressure within the single flexible storage tank may be difficult to monitor and predict when the flexible storage tank is empty and may be desirable to decouple the flexible storage tank from the catalytic rebalancing cell. As an alternative, the gas storage system may use two tanks to allow for a buffering (e.g., auxiliary) tank to maintain a positive pressure until the gas storage system can be decoupled. Further, the two tanks may include a weighted main tank which may enable a more gradual change in pressure as a volume of the weighted main tank increases.

The electrolyte management system may also include a redox rebalancing cell which offers advantages over a hydrogen catalytic rebalancing cell, the hydrogen catalytic rebalancing reactor relying on equation (4) for reducing Fe³⁺. The hydrogen catalytic rebalancing reactor may rely on use of a precious metal catalyst such as platinum, which may increase a start-up cost for implementing the hydrogen catalytic rebalancing cell. Additionally, the catalyst may undergo cleaning and recovery after a period of use which may increase a down-time and labor associated with the hydrogen catalytic rebalancing cell. A redox rebalancing cell may instead use a reducing agent already present within the iron-flow battery system, Fe⁰ which may react with Fe³⁺ at an appreciable rate without a catalyst present. However, in some examples, the redox rebalancing cell may be configured with a catalyst to further increase a rate of the rebalancing reaction.

Referring now to FIG. 2, a first example 200 of a redox rebalancing cell 204 for redox flow battery 202 is shown. Redox rebalancing cell 204 may be configured as a shorted redox rebalancing cell and may be herein referred to as shorted redox rebalancing cell 204. Redox flow battery 202 may be similar to redox flow battery 10 of FIG. 1. Redox flow battery 202 may include a negative electrode compartment 208 and a positive electrode compartment 210 separated by a membrane 216 and electrically coupled via conductor 212. A negative electrode (e.g., plating electrode) 206 may be in fluid communication with negative electrolyte within negative electrode compartment 208. Redox flow battery 202 may be charged by an external electrical load 211 which drives Fe²⁺ in negative electrode compartment 208 to be plated onto negative electrode 206 and Fe²⁺ in positive electrolyte within positive electrode compartment 210 to be oxidized to Fe³⁺. Unwanted Fe³⁺ may become present in negative electrode compartment 208 due, in some examples, to Fe³⁺ from positive electrode compartment 210 permeating membrane 216 and entering negative electrode compartment 208. Additionally or alternatively, Fe³⁺ may be electrochemically generated in negative electrode compartment 208 during discharge of redox flow battery 202.

Negative electrolyte may flow from negative electrode compartment 208 to a rebalancing electrode 203. Plating electrode 206 and rebalancing electrode 203 may together comprise the shorted redox rebalancing cell 204. Rebalancing electrode 203 may be an electrode electrically coupled (e.g., shorted) to negative electrode 206 via conductive wire 214 and negative electrolyte may flow through rebalancing electrode 203 and on to a negative electrolyte tank 222 following arrow 218. In one example, redox flow battery 202 may be one of a plurality of redox flow batteries coupled together forming an electrode stack. In such an example, negative electrode 206 may be a negative endplate electrode of the electrode stack including a plurality of electrodes and bipolar plates. The negative endplate electrode may be prone to asymmetrical plating due to an imbalance caused by shunt losses across a stack of electrodes of the electrode stack.

In one example, as shown in first example 200, positive electrolyte may flow from positive electrode compartment 210 to a positive electrolyte tank 220 following arrow 219. Positive electrolyte may not include undesirable Fe³⁺ and so may not be directed to shorted redox rebalancing cell 204. In some examples, negative electrolyte tank 222 and positive electrolyte tank 220 may be part of a monolithic multi-chambered electrolyte storage tank such as multi-chambered electrolyte storage tank 110 of FIG. 1. Positive electrolyte may be circulated from positive electrolyte tank 220 back to positive electrode compartment 210 following arrow 226, and negative electrolyte may be circulated from negative electrolyte tank 222 back to negative electrode compartment 208 following arrow 228.

To facilitate a high reactivity between the negative electrolyte and the rebalancing electrode 203 without hindering a flow rate of the negative electrolyte, the rebalancing electrode 203 may be formed of a large surface area material. Additionally, rebalancing electrode 203 may be formed of a conductive material for facilitating electrochemical reactions. For example, the large surface area conductive material may be formed of activated carbon having a surface area greater than 700 m²/g. In other examples, the surface area of the material forming rebalancing electrode 203 may be greater than 1000 m²/g.

Negative electrode 206 may be physically and electrically coupled (e.g., shorted) to rebalancing electrode 203 via a conductor 214. In this way, Fe³⁺ present in the negative electrolyte may be oxidized to Fe²⁺ by Fe⁰ plated on negative electrode 206. A driving force for this reaction may be between 1.0V and 1.2V as described by equation 5 and 6 above. In an example where negative electrode 206 is the negative endplate electrode, using Fe⁰ plated on negative electrode 206 to reduce Fe³⁺ may alter a thickness of Fe⁰ on negative electrode 206, resulting in a more uniform plating thickness across an area of negative electrode 206 which may enhance a performance of redox flow battery 202.

An electrical resistance between negative electrode 206 and rebalancing electrode 203 across conductor 214 may be minimized by configuring rebalancing electrode 203 as close to negative electrode 206 as possible, thereby minimizing a length of conductor 214 mediating the short therebetween, conductor 214 providing a path for current flow. In one example, shorted redox rebalancing cell 204 may include a power supply 224 configured to apply a low voltage potential between negative electrode 206 and rebalancing electrode 203 at a polarity to increase a rate at which Fe³⁺ is reduced to Fe²⁺ by Fe⁰ (e.g., a reverse voltage potential). Additionally, a performance of shorted redox rebalancing cell 204 may be increased by minimizing plating of Fe⁰ on rebalancing electrode 203. Plating of Fe⁰ on rebalancing electrode 203 may be minimized by maintaining the low voltage potential above a threshold potential and/or by increasing a resistance between negative electrolyte inside the redox flow battery 202 and inside rebalancing electrode 203.

In an alternative type of redox rebalancing reactor, the Fe⁰ for reducing Fe³⁺ may be separately plated onto a sacrificial electrode of the redox rebalancing cell. The sacrificial electrode may be part of the redox rebalancing cell and not used for storing energy as part of redox flow battery. Such an example is shown in FIGS. 3A-3B. A sacrificial redox rebalancing cell 302 is shown during a first stage 300 and a second stage 350 of operation, respectively, where the stages are operating modes of sacrificial redox rebalancing cell 302. Operation of the redox rebalancing cell 302 may therefore be alternated between first stage 300 and second stage 350, according to operating conditions.

Sacrificial redox rebalancing cell 302 which may be coupled to a redox flow battery system, such as the redox flow battery system 10 of FIG. 1 downstream of a redox battery cell 301 (similar to redox flow battery cell 18 of FIG. 1) including a positive electrode compartment 312 and a negative electrode compartment 314. Further, sacrificial redox rebalancing cell 302 may be upstream of positive electrolyte tank 316 and negative electrolyte tank 318. In some examples, positive electrolyte tank 316 and negative electrolyte tank 318 may be included in a multi-chambered electrolyte storage tank, such as multi-chambered electrolyte storage tank 110 of FIG. 1. While FIGS. 3A-3B show a single sacrificial redox rebalancing cell 302, configurations with multiple redox rebalancing cells including sacrificial redox rebalancing cells and/or shorted redox rebalancing cells are connected in series or parallel have been considered. Sacrificial redox rebalancing cell 302 may reduce a concentration of Fe³⁺ in a negative electrolyte of the redox flow battery system by reacting Fe³⁺ with Fe⁰ plated on a plating electrode 304 (e.g., negative electrode or sacrificial anode).

As described above, sacrificial redox rebalancing cell 302 is shown in FIGS. 3A and 3B in two different operating modes or stages, e.g., first stage 300 and second stage 350. First stage 300 and second stage 350 may occur sequentially within the same sacrificial redox rebalancing cell 302. Sacrificial redox rebalancing cell 302 may further include a positive electrode 306 separated by a separator 308. Separator 308 may be in face sharing contact with both plating electrode 304 and positive electrode 306. Plating electrode 304, separator 308 and positive electrode 306 may be stacked on top of each other in a stacking direction indicated by arrow 322. Plating electrode 304 may be formed of a conductive material conducive to forming an even plating layer or layers of iron. In one example, plating electrode 304 may be configured similar to a plating electrode of a redox flow battery such as negative electrode 26 of FIG. 1. In another example, plating electrode 304 may be formed of a porous and conductive material such as conductive felt configured to provide a large surface area to volume ratio upon which a thin layer of iron may be plated. Positive electrode 306 may be formed of a high surface area conductive material. In one example, positive electrode 306 may be formed of a high surface area carbon material. Separator 308 may be an ion conductive material that circumvents electrical shorting between plating electrode 304 and positive electrode 306 while allowing balancing ions to flow therebetween.

Electrolyte may flow through cavities of electrodes of sacrificial redox rebalancing cell 302, in a direction perpendicular to the stacking direction, contacting both the plating electrode 304 and positive electrode 306. In some examples, plating electrode 304, positive electrode 306, and separator 308 may be flexible materials such that sacrificial redox rebalancing cell 302 may be in a rolled configuration housed within a tube.

At first stage 300, positive electrolyte from positive electrode compartment 312, similar to positive electrode compartment 22 of FIG. 1, may be directed through redox rebalancing cell 302, as described above, before flowing to positive electrolyte tank 316 following arrows 320. A first voltage may be applied between plating electrode 304 and positive electrode 306 by a power supply 310 via wire 311. The first voltage may drive reduction of Fe²⁺ in the positive electrolyte to Fe⁰ which may plate onto plating electrode 304 while Fe²⁺ may be oxidized to Fe³⁺ at positive electrode 306. In one example, first stage 300 may start when the redox flow battery is close to or fully discharged. In this way, significant parasitic power loss may be mitigated. For example, a concentration of Fe³⁺ in the positive electrolyte may be minimized, and a concentration of Fe²⁺ may be maximized without reducing an amount of power available to the redox flow battery by using up Fe²⁺ before it can be plated at a plating electrode of the redox flow battery cell. First stage 300 may end when a sufficient thickness of Fe⁰ may be plated on plating electrode 304 and the positive electrolyte is fully drained from sacrificial redox rebalancing cell 302 into the positive electrolyte tank.

FIG. 3B shows second stage 350 of operating sacrificial redox rebalancing cell 302. At second stage 350, a negative electrolyte from negative electrode compartment 314 (similar to negative electrode compartment 20 of FIG. 1) may be directed into sacrificial redox rebalancing cell 302. Fe⁰ plated on plating electrode 304 at first stage 300 may contact Fe³⁺ in the negative electrolyte and reduce Fe³⁺ to Fe²⁺. Additionally, positive electrode 306 may be electrically shorted to plating electrode 304. In this way, Fe³⁺ in the negative electrolyte may be reduced to Fe²⁺ by contacting positive electrode 306. In one example, a rate of reduction of Fe³⁺ at the positive electrode may also be increased by a second voltage applied by power supply 310. The second voltage may be a reverse voltage (e.g., opposite polarity relative to the plating potential at first stage 300) applied between positive electrode 306 and plating electrode 304. The negative electrolyte exiting sacrificial redox rebalancing cell 302 may return to negative electrolyte tank 318 and back to negative electrode compartment 314 following arrow 352. Redox rebalancing cell 302 may be drained of negative electrolyte before it is operated in according to first stage 300.

In addition to redox rebalancing cells, a redox flow battery system (such as redox flow battery system 10 of FIG. 1) may include rebalancing reactors which reduce unwanted Fe³⁺ in positive and/or negative electrolyte to Fe²⁺ by reacting Fe³⁺ with H₂ gas in the presence of a catalyst. Conveniently, the H₂ gas may be generated by side reactions of the electrolytes and captured in a headspace of a multi-chambered electrolyte storage tank (such as multi-chambered electrolyte storage tank 110 of FIG. 1). Additional hydrogen gas may be stored at relatively low pressures in a flexible gas storage tank. A volume of gas stored in the flexible gas storage tank may be difficult to determine and may therefore increase a likelihood that the flexible gas storage tank may be emptied creating an undesired vacuum condition between the flexible gas storage tank and the catalytic rebalancing cell and thereby the redox flow battery system. The above issues may be at least partially addressed by a gas storage system as described below with respect to FIGS. 4A-4C.

FIGS. 4A-4C show first step 400, second step 430, and third step 460 of operating gas storage system 401. Gas storage system 401 may include a first gas storage tank 402 and a second gas tank 404. Walls of first gas storage tank 402 and second gas storage tank 404 may be flexible, and first gas storage tank 402 and second gas storage tank 404 may also be referred to as first expandable gas tank 402 and second expandable gas tank 404. Additionally, herein first gas storage tank 402 may be referred to as auxiliary tank 402 and second gas storage tank 404 may be referred to main tank 404. Auxiliary tank 402 and main tank 404 may be expandable gas storage tanks including flexible walls which may expand to hold a threshold volume of gas at a designated pressure. When expanded a maximum amount, a volume of auxiliary tank 402 may be a smaller maximum volume than a maximum volume of main tank 404. In one example, auxiliary tank 402 and main tank 404 may each formed as a cylindrical tube with material gathered to seal the cylinder openings. Other shapes of auxiliary tank 402 and main tank 404 have been considered including spheroids, pistons, and/or accordion folded material.

Main tank 404 may be fluidly coupled to auxiliary tank 402. In one example, the fluidic coupling between main tank 404 and auxiliary tank 402 may be configured to allow gas to flow both from auxiliary tank 402 to main tank 404 and vice versa, as shown by arrow 412. Additionally, gas storage system 401 may include a pressure transducer 422 coupled to either auxiliary tank 402 or main tank 404. Auxiliary tank 402 may be configured to receive hydrogen gas from a hydrogen source 408 as shown by arrow 414. In one example, hydrogen source 408 may at least one electrolyte storage tank. In such an example, hydrogen source 408 be a multi-chambered electrolyte storage tank such as multi-chambered electrolyte storage tank 110 of FIG. 1 which includes a gas head space configured to receive hydrogen gas evolved from electrolytes. Auxiliary tank 402 may be configured to deliver hydrogen gas to an electrolyte rebalancing system 410 as shown by arrow 416. In one example, the electrolyte rebalancing system may include rebalancing reactors (similar to rebalancing reactors 80 and 82 of FIG. 1). In this way, gas storage system 401 may store hydrogen gas generated by a redox flow battery system and provide hydrogen gas as a reactant to the hydrogen catalytic rebalancing cell.

Distributed force 406 may be in face sharing contact with a top side of main tank 404. The top side of main tank 404 may be the top side with respect to the direction of gravity as shown by arrow 418. Distributed force 406 may be configured to supply an uneven force against inflating of main tank 404, which may lead to a technical effect of a measurable pressure rise during inflation of main tank 404. For example, distributed 406 may be a distributed weight placed on the top side and configured to be lighter at a first side, gradually increase in weight in a horizontal direction, perpendicular to the direction of gravity, and may be heaviest at a second side, opposite the first side. In one example, the distributed weight may be wedge shaped or a weighted tape. Other shapes of the distributed weight have been considered. In one example, a shape of the distributed weight may be chosen to be complementary a shape of main tank 404 (e.g., a cone shaped distributed weight if the main tank is circular). In other examples, distributed force 406 may be a plurality of weights, each formed of a different mass and distributed across a top side of main tank 404. In another example, distributed force 406 may be a linear spring force pressing against the top side. The linear spring force may be configured to press with variable force against the top side, increasing from a light spring force at the first side in a horizontal direction to be a stronger spring force at the second side. Main tank 404 may further include a pressure relief valve 420 configured to open and vent gas from main tank 404 when a pressure inside main tank 404 increases beyond a safe operating pressure range for gas storage system 401 and close again when pressure decreases to be within the safe operating range.

FIG. 4A shows first step 400 where an amount of hydrogen gas stored in gas storage system 401 is low, e.g., lower than in FIGS. 4B and 4C, and has not received hydrogen gas from the multi-chamber electrolyte storage tank. In other words, auxiliary tank 402 and main tank 404 may not include enough gas to exert pressures on the walls of auxiliary tank 402 and/or main tank 404.

FIG. 4B shows second step 430 with gas storage system 401 at substantially atmospheric pressure (e.g., 101 kPa) and at least partially filled with gas. Gas may be received by gas storage system 401 from hydrogen source 408 and may expand both auxiliary tank 402 and main tank 404 while a pressure inside auxiliary tank 402 and main tank 404 may be substantially equal (e.g., close to atmospheric pressure). In one example, substantially equal to atmospheric pressure may be within 0.5 kPa of atmospheric pressure. Auxiliary tank 402 may expand to a maximum volume without causing the pressure measured by pressure transducer 422 to increase by an easily measurable amount before gas enters main tank 404 due be compressed by a compressive force of the distributed force 406 on the walls of main tank 404.

FIG. 4C shows third step 460 with gas storage system 401 completely full. After auxiliary tank 402 is filled to the maximum volume, gas may be received by main tank 404. A change in pressure inside main tank 404 may be measured by pressure transducer 422 even when the walls of the tank are not fully expanded due to the force of distributed force 406 against the walls of main tank 404. In one example, a weight of distributed weight may correspond to an operating pressure range of 0.5 kPa-5 kPa. A maximum volume of main tank 404 may be reached when a pressure of gas in gas storage system 401 is enough to push against the total mass of distributed force 406 and fully expand the walls of main tank 404. Excess gas added once main tank 404 is expanded to a maximum volume may be vented through the pressure relief valve 420.

Turning now to FIG. 5, a plot 500 is shown including trace 501 which corresponds to a volume of a gas storage system, such as gas storage system 401 of FIGS. 4A-4C, as a function of pressure of the gas storage system. The gas storage system may include both an auxiliary tank and a main tank. At section 502, trace 501 corresponds to a relationship between volume and pressure when an auxiliary tank (such as auxiliary tank 402 of FIGS. 4A-4C) is being filled and before a main tank (such as main tank 404 of FIGS. 4A-4C) is filled. At lower volumes, volume increases with only small changes in pressure as the auxiliary tank expands to a maximum volume. A maximum volume of the auxiliary tank is reached at point 503 of trace 501. At point 503 a slope of trace 501 decreases. In other words, the pressure of the gas storage system increases with minimal changes in a volume of the system. Section 504 of plot 500 corresponds to gas filling a main tank configured with a distributed weight while the auxiliary tank is maintained at the maximum volume of the auxiliary tank. Point 505 corresponds to a step change in pressure. Gas beginning to fill the main tank and pressing against the distributed weight may cause the step change which may be measured by a pressure transducer coupled to the gas storage system (e.g., pressure transducer 422 of FIGS. 4A-4C). At section 504, pressure measured inside the gas storage system correlates to volume of gas in the gas storage system and trace 501 demonstrates a linear relationship between pressure and volume. The linearity of section 504 may allow a measured pressure to be calibrated with respect to a volume of the gas storage system, given a known maximum value of the auxiliary tank in addition to the linear relationship of pressure to volume added to the main tank. Further, when the gas in the gas storage system is being used up by a rebalancing reactor, a change in slope of trace 501 in the transition from section 502 to 504 may indicate that the main tank is empty. The change in slope may be characteristic of the main tank changing from a filled state to an empty state and may be distinguishable in magnitude from the slope of trace 501 changing due to a change in operating state of the redox flow battery (e.g., from a charging state to an idle state). Section 506 shows trace 501 ending once a maximum pressure and volume are reached. This may be due to action of a pressure relief valve as described above with respect to FIGS. 4A-4C configured to release gas to the atmosphere to maintain a maximum operating pressure of the gas storage system. In one example, the maximum operating pressure may be 10 kPa. In an alternate example, the maximum operating pressure may be 20 kPa.

Turning now to FIG. 6 an example of a method 600 for operating a redox rebalancing cell of an electrolyte management system is shown. The redox rebalancing cell may be one of the two embodiments of the redox rebalancing cells described above with respect to FIGS. 2-3B. The redox rebalancing cell may be implemented in a redox flow battery system (such as redox flow battery system 10 of FIG. 1) for decreasing an amount of Fe³⁺ in a negative electrolyte, for example as well as for treating a positive electrolyte. At least some steps or portions of steps may be carried out via the controller 88 of FIG. 1, and may be stored as executable instructions at a non-transitory storage medium (e.g., non-transitory memory) communicably coupled to controller 88. The method 600 may be executed upon activation of the redox flow battery system. For example, electrolyte flow may be driven and controlled by one or more pumps and valves and the battery system may be operating in a charging, discharging, or idling mode.

Method 600 may be performed to remediate degradation of the electrolyte. Electrolyte degradation may be determined by measuring a concentration of Fe³⁺ and/or hydrogen gas in the negative electrolyte, among other methods. As one example, concentration of Fe³⁺ in negative electrolyte may be determined by colorimetric or oxidation reduction potential (ORP) sensors. Further, a degraded performance of the redox flow battery as measured by a deviation of expected current and/or voltage values for a given power may also indicate an amount of Fe³⁺ may be present in a negative electrolyte of the redox flow battery system. In one example method 600 may be performed continuously during normal operation of the redox flow battery thereby continuously remediating electrolyte regardless of level of degradation.

At 602, method 600 includes plating iron onto a plating electrode of a redox rebalancing cell. In an example where the redox rebalancing cell is a shorted redox rebalancing cell such as shorted redox rebalancing cell 204 of FIG. 2, the plating iron onto the plating electrode may be a negative electrode of the redox flow battery and step 602 may include, at step 601, operating the redox flow battery operating in a charging mode. In another example, the redox rebalancing cell may be a sacrificial redox rebalancing cell and step 602 may include, at step 603, flowing positive electrolyte through the sacrificial redox rebalancing cell while simultaneously applying a voltage across the sacrificial redox rebalancing cell until a desired thickness of the iron plating is obtained. Flow of the positive electrolyte through the sacrificial redox rebalancing cell may be directed when the redox flow battery system is approaching a fully discharged state or in a substantially discharged state.

At 604, method 600 includes treating the electrolyte (e.g., the negative electrolyte) with the redox rebalancing cell. Treating the electrolyte may include directing the electrolyte towards at least an electrode of the redox rebalancing cell where reduction of Fe³⁺ may occur. In the example where the redox rebalancing cell is shorted rebalancing cell, the electrode may be a high surface area electrode electrically shorted to the plating electrode (e.g., negative electrode) of the redox flow battery system. Treating the electrolyte may include reducing Fe³⁺ in the negative electrolyte with Fe⁰ and may optionally including providing a voltage bias with a power source to increase a rate of the reduction reaction.

In another example where the redox rebalancing cell is a sacrificial redox rebalancing cell, the electrode may include both the sacrificial plating electrode and a positive electrode of the sacrificial redox rebalancing cell. In such an example where the electrode may include both the sacrificial and plating electrode, treating the electrolyte at 604 may include adjusting the redox rebalancing cell from a first operating mode to a second operating mode as described above with respect to FIGS. 3A-3B.

Fe³⁺ may be reduced when Fe³⁺ gains electrons from the plated Fe⁰. Electrons may travel from the plated Fe⁰ by establishing an electrical short is between the plating electrode and positive electrode of the redox rebalancing cell to allow electrons from the plating electrode to flow to the positive electrode or by directly contacting the electrolyte including Fe³⁺ ions with the plated Fe⁰ (as shown in FIG. 3B above). In this way, Fe⁰ on the plating electrode may reduce Fe³⁺ in the negative electrolyte to Fe²⁺. In one example, where the redox rebalancing cell includes the sacrificial plating electrode a reverse potential may be applied between the positive electrode and the sacrificial plating electrode to further drive the flow of electrons from the Fe⁰ plating electrode to the positive electrode where reduction of the Fe³⁺ occurs.

Method 600 may then proceed to 606 and includes returning treated electrolyte to an electrolyte storage tank (such as multi-chambered electrolyte storage tank 110 of FIG. 1). In this way, electrolyte may continually cycle through the redox flow battery while also undergoing remediation for presence of Fe³⁺. In some examples electrolyte may also pass through a hydrogen catalytic rebalancing cell upstream or downstream of the redox rebalancing cell.

The technical effect of method 600 as described in FIG. 6 may have the effect improving a health of the electrolyte by reducing an amount of Fe³⁺ in the negative electrolyte and decreasing a probability of Fe₃(OH) precipitation. Further, in some examples, iron plating on a negative endplate electrode may be dissolved to achieve a uniform plating thickness across an area of the negative endplate electrode. Additionally or alternatively, the electrolyte may be remediated by use of a hydrogen catalytic rebalancing cell which uses hydrogen gas as the reductant instead of Fe⁰. Hydrogen for a catalytic rebalancing cell may be evolved by side reactions of the electrolytes and collected in a headspace of multi-chamber electrolyte storage tank (such as multi-chamber electrolyte storage tank 110 of FIG. 1) and further stored in a gas storage system.

Turning now to FIG. 7 an example of a method 700 for operating a gas storage system of an electrolyte management system is shown. The gas storage system may be similar to the gas storage system 401 as described above with respect to FIGS. 4A-4C. The gas storage system may store hydrogen gas collected from the headspace of the multi-chamber electrolyte storage system and feed hydrogen gas to a rebalancing reactor. In one example, the rebalancing reactor may be a hydrogen catalytic rebalancing reactor. At least some steps or portions of steps may be carried out via the controller 88 of FIG. 1, and may be stored as executable instructions at a non-transitory storage medium (e.g., non-transitory memory) communicably coupled to controller 88. The method 700 may be executed upon activation of the redox flow battery system. For example, electrolyte flow may be driven and controlled by one or more pumps and valves and the battery system may be operating in a charging, discharging, or idling mode.

At 702, method 700 includes fluidly coupling the gas storage system to an electrolyte storage tank. In one example, the electrolyte storage tank may be similar to multi-chambered electrolyte storage tank 110 of FIG. 1. In this way, the gas storage system may receive hydrogen generated by side reactions of electrolytes of the redox flow battery system. Hydrogen gas may enter both an auxiliary tank and a main tank of the gas storage system as described above with respect to FIGS. 4A-4C.

At 704, method 700 includes measuring a pressure of gas within the gas storage system. Measuring the gas storage system pressure may include correlating a measured pressure to an available volume of the gas storage system in terms of number of moles of hydrogen gas.

At 706, method 700 includes determining if the pressure is greater than or equal to a threshold operating pressure. The threshold operating pressure may be the pressure at which the auxiliary tank is full and enough gas has entered the main tank to push against a distributed weight in face sharing contact with the main tank. In one example, the threshold operating pressure may be between 0.5 kPa and 5 kPa. In another example, the threshold operating pressure may be between 2 kPa and 4 kPa, although other threshold operating pressures have been considered. If the pressure is above or equal to the threshold operating pressure, method 700 proceeds to 708 and includes fluidly coupling the gas storage system the catalytic rebalancing reactor. In some examples, the gas storage system may be coupled to the rebalancing reactor and step 708 includes maintaining fluid coupling between the gas storage system and the rebalancing reactor. The rebalancing reactor may be a hydrogen catalytic rebalancing reactor and may use hydrogen gas to reduce Fe³⁺ to Fe²⁺ in the presence of a catalyst.

If the measured pressure is a less than the minimum operating pressure, then method 700 proceeds to 710 and includes decreasing an amount of hydrogen gas in the rebalancing reactor. A measured pressure less than the minimum operating pressure may indicate that the main tank is empty, but the auxiliary tank may still be full. In one example an amount of hydrogen gas in the rebalancing reactor may be decreased by decoupling the gas storage system from the rebalancing reactor at 712. In an example where the gas storage system is decoupled from the hydrogen catalytic rebalancing reactor when the pressure is measured at step 704, decoupling the gas storage system may include maintaining the gas storage system decoupled from the hydrogen catalytic rebalancing reactor. Gas in the auxiliary tank may maintain a positive pressure between the gas storage system and hydrogen catalytic rebalancing reactor (and thereby the redox flow battery system) and may provide enough time for the two systems to be decoupled. Additionally, the auxiliary tank may mitigate formation of a vacuum in the redox flow battery when the redox flow battery is shut down. In another example, an amount of hydrogen gas in the hydrogen catalytic rebalancing cell may be decreased by removing electrolyte from the rebalancing reactor at 714 thereby removing the reactant consuming the hydrogen gas.

At 716, method 700 includes maintaining a fluid coupling of the gas storage system and the multi-chamber electrolyte storage tank. In this way, an amount of gas stored in the gas storage system may continue to increase. The system may automatically correct for pressure inside the gas storage system going above an operating range by use of a pressure release valve as described above with respect to FIGS. 4A-4C. Method 700 returns.

The technical effect of method 700 is that hydrogen gas that may be collected for use in a rebalancing reactor may be monitored and controlled more accurately and precisely using a gas storage system. The gas storage system may allow a more accurate determination of available gas volume without relying on stable reduction rates and may allow for reliably decoupling the gas storage system before it reaches an empty state. Additionally, an electrolyte management system may be less dependent on costly catalysts and utilize generated hydrogen gas more efficiently. Remediating negative electrolyte using a redox rebalancing cell may decrease a cost associated with the electrolyte management system and may, in some embodiments, also increase a plating quality, e.g., an evenness or uniformity, of the Fe⁰ at the plating electrode.

The disclosure also provides support for a gas storage system for a redox flow battery, comprising: a set of expandable gas storage tanks coupled to at least one electrolyte storage tank and an electrolyte rebalancing system of the redox flow battery, the set of expandable gas storage tanks including a first gas storage tank fluidly coupled to a second gas storage tank, and wherein the first gas storage tank is configured to receive a gas from the at least one electrolyte storage tank before the second gas storage tank and the second gas storage tank is compressed by a distributed weight. In a first example of the system, the first gas storage tank is configured to receive the gas until a volume of the first gas storage tank reaches a maximum volume, and to deliver the gas to the second gas storage tank after the first gas storage tank reaches the maximum volume. In a second example of the system, optionally including the first example, a pressure of the first gas storage tank at the maximum volume is substantially atmospheric pressure. In a third example of the system, optionally including one or both of the first and second examples, the second gas storage tank is configured to receive the gas until a pressure of the gas storage system reaches a maximum pressure. In a fourth example of the system, optionally including one or more or each of the first through third examples, the maximum pressure of the second gas storage tank is in a range of 0.5 kPa to 10 kPa. In a fifth example of the system, optionally including one or more or each of the first through fourth examples, the second gas storage tank includes a pressure relief valve configured to open and vent excess gas when the pressure of the gas storage system is above the maximum pressure. In a sixth example of the system, optionally including one or more or each of the first through fifth examples, the distributed weight is configured to increase in weight from a first side of the distributed weight to a second side of the distributed weight. In a seventh example of the system, optionally including one or more or each of the first through sixth examples, the gas storage system further includes a pressure transducer configured to measure a pressure within the first gas storage tank and the second gas storage tank, wherein the pressure is related to a volume of gas in the gas storage system. In a eighth example of the system, optionally including one or more or each of the first through seventh examples, the first gas storage tank has a smaller maximum volume than the second gas storage tank.

The disclosure also provides support for a method for a gas storage system for a redox flow battery, comprising: receiving gas from an electrolyte storage tank at a first expandable gas tank until a volume of the first expandable gas tank reaches a maximum volume, and receiving gas from the electrolyte storage tank at a second expandable gas tank via the first expandable gas tank, the second expandable gas tank compressed by a distributed weight, when the first expandable gas tank is at the maximum volume. In a first example of the method, the method further comprises: using the gas stored in the first expandable gas tank to mitigate formation of a vacuum in the redox flow battery when the redox flow battery is shut down. In a second example of the method, optionally including the first example, the first expandable gas tank is maintained at substantially atmospheric pressure. In a third example of the method, optionally including one or both of the first and second examples, the method further comprises: venting the second expandable gas tank via a pressure relief valve when the second expandable gas tank reaches a maximum pressure and additional gas is delivered to the second expandable gas tank. In a fourth example of the method, optionally including one or more or each of the first through third examples, receiving gas from the second expandable gas tank causes a step change in pressure registered by a pressure transducer coupled to the gas storage system.

The disclosure also provides support for a redox flow battery system, comprising: a redox flow battery cell including a negative electrode compartment and a positive electrode compartment, an electrolyte storage tank fluidly coupled to the redox flow battery cell, a rebalancing reactor fluidly coupled to the redox flow battery cell and the electrolyte storage tank, a gas storage system including a first expandable gas tank fluidly coupled to the electrolyte storage tank and the rebalancing reactor, a second expandable gas tank fluidly coupled to the first expandable gas tank, a distributed weight positioned on a top side of the second expandable gas tank, and a controller including executable instructions stored in non-transitory memory thereon to: measure a pressure of the gas storage system, in response to the pressure being greater than or equal to a threshold operating pressure, maintain fluidic coupling between the gas storage system and the rebalancing reactor, and in response to the pressure being less than the threshold operating pressure, decrease an amount of hydrogen gas in the rebalancing reactor. In a first example of the system, instructions to decrease the amount of hydrogen gas include to decouple the gas storage system from the rebalancing reactor or to remove an amount of electrolyte from to the rebalancing reactor. In a second example of the system, optionally including the first example, the pressure correlates to a volume of gas in the gas storage system. In a third example of the system, optionally including one or both of the first and second examples, the gas storage system is configured to receive gas evolved from electrolytes stored in the electrolyte storage tank. In a fourth example of the system, optionally including one or more or each of the first through third examples, a shape of the distributed weight is complementary to a shape of the second expandable gas tank. In a fifth example of the system, optionally including one or more or each of the first through fourth examples, the electrolyte storage tank is a multi-chambered electrolyte storage tank including a gas head space to store gas evolved from an electrolyte of the redox flow battery system.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A gas storage system for a redox flow battery, comprising:
a set of expandable gas storage tanks coupled to at least one electrolyte storage tank and an electrolyte rebalancing system of the redox flow battery, the set of expandable gas storage tanks including a first gas storage tank fluidly coupled to a second gas storage tank, and wherein the first gas storage tank is configured to receive a gas from the at least one electrolyte storage tank before the second gas storage tank and the second gas storage tank is compressed by a distributed force.

2. The gas storage system of claim 1, wherein the first gas storage tank is configured to receive the gas until a volume of the first gas storage tank reaches a maximum volume, and to deliver the gas to the second gas storage tank after the first gas storage tank reaches the maximum volume.

3. The gas storage system of claim 2, wherein a pressure of the first gas storage tank at the maximum volume is substantially atmospheric pressure.

4. The gas storage system of claim 2, wherein the second gas storage tank is configured to receive the gas until a pressure of the gas storage system reaches a maximum pressure.

5. The gas storage system of claim 4, wherein the maximum pressure of the second gas storage tank is in a range of 0.5 kPa to 20 kPa.

6. The gas storage system of claim 4, wherein the second gas storage tank includes a pressure relief valve configured to open and vent excess gas when the pressure of the gas storage system is above the maximum pressure.

7. The gas storage system of claim 1, wherein the distributed force is a linear spring force or a distributed weight, and is configured to increase in force from a first side of the distributed force to a second side of the distributed force.

8. The gas storage system of claim 1, wherein the gas storage system further includes a pressure transducer configured to measure a pressure within the first gas storage tank and the second gas storage tank, wherein the pressure is related to a volume of gas in the gas storage system.

9. The gas storage system of claim 1, wherein the first gas storage tank has a smaller maximum volume than the second gas storage tank.

10. A method for a gas storage system for a redox flow battery, comprising:
receiving gas from an electrolyte storage tank at a first expandable gas tank until a volume of the first expandable gas tank reaches a maximum volume; and
receiving gas from the electrolyte storage tank at a second expandable gas tank via the first expandable gas tank, the second expandable gas tank compressed by a distributed force, when the first expandable gas tank is at the maximum volume.

11. The method of claim 10, further comprising using the gas stored in the first expandable gas tank to mitigate formation of a vacuum in the redox flow battery when the redox flow battery is shut down.

12. The method of claim 10, wherein the first expandable gas tank is maintained at substantially atmospheric pressure.

13. The method of claim 10, further comprising venting the second expandable gas tank via a pressure relief valve when the second expandable gas tank reaches a maximum pressure and additional gas is delivered to the second expandable gas tank.

14. The method of claim 10, wherein receiving gas from the second expandable gas tank causes a step change in pressure registered by a pressure transducer coupled to the gas storage system.

15. A redox flow battery system, comprising:
a redox flow battery cell including a negative electrode compartment and a positive electrode compartment;
an electrolyte storage tank fluidly coupled to the redox flow battery cell;
a rebalancing reactor fluidly coupled to the redox flow battery cell and the electrolyte storage tank;
a gas storage system including a first expandable gas tank fluidly coupled to the electrolyte storage tank and the rebalancing reactor, a second expandable gas tank fluidly coupled to the first expandable gas tank, a distributed force positioned on a top side of the second expandable gas tank; and
a controller including executable instructions stored in non-transitory memory thereon to:
measure a pressure of the gas storage system;
in response to the pressure being greater than or equal to a threshold operating pressure, maintain fluidic coupling between the gas storage system and the rebalancing reactor; and
in response to the pressure being less than the threshold operating pressure, decrease an amount of hydrogen gas in the rebalancing reactor.

16. The redox flow battery system of claim 15, wherein instructions to decrease the amount of hydrogen gas include to decouple the gas storage system from the rebalancing reactor or to remove an amount of electrolyte from to the rebalancing reactor.

17. The redox flow battery system of claim 15, wherein the pressure correlates to a volume of gas in the gas storage system.

18. The redox flow battery system of claim 15, wherein the gas storage system is configured to receive gas evolved from electrolytes stored in the electrolyte storage tank.

19. The redox flow battery system of claim 15, wherein the distributed force is a distributed weight, and a shape of the distributed weight is complementary to a shape of the second expandable gas tank.

20. The redox flow battery system of claim 15, wherein the electrolyte storage tank is a multi-chambered electrolyte storage tank including a gas head space to store gas evolved from an electrolyte of the redox flow battery system.
